(19) United States
(12) Patent Application Publication
(10) Pub. No.: US 2011/0179915 A1
(43) Pub. Date: Jul. 28, 2011

(54) UNIVERSAL JOINT CAPABLE OF REPLACING VARIOUS TOOL SETS

(76) Inventor: Cheng-Chia PENG, Taichung (TW)

(21) Appl. No.: 13/014,718

(22) Filed: Jan. 27, 2011

(30) Foreign Application Priority Data
Jan. 28, 2010 (TW) 0991024444

(51) Int. Cl. B25B 23/00

(52) U.S. Cl. 81/177.75

(57) ABSTRACT

An universal joint capable of replacing various tool sets contains a tool set having a driving portion disposed on one end thereof and a spherical knob fixed on another end thereof, and the spherical knob includes two retaining segments disposed on two sides thereof respectively; a holder having a fitting portion disposed on one end thereof and a chamber fixed on another end thereof to receive the spherical knob, and between the holder and the tool set being defined a locking structure, wherein the locking structure includes a hole fixed on the retaining segment of the tool set to communicate with the chamber. The hole includes a lock boss placed therein, and the holder also includes a sleeve member fitted thereon. The sleeve member includes an abutting face for pushing the lock boss to extend out of the chamber of the holder to engage with the retaining segments.

### BACKGROUND OF THE PRESENT INVENTION

1. Field of Invention

The present invention relates to an universal joint capable of rotating the holder and the tool set simultaneously and replacing various tool sets to save production cost and being carried easily.

2. Description of Related Arts

As shown in FIG. 1, a conventional universal joint disclosed in TW Pat. No. 87218189 includes an universal socket 10 having a tool set 11 and a holder 12, wherein the tool set 11 includes a driving portion 111 with a steel ball disposed on one end thereof and formed in a tetragonal column shape, and includes a spherical knob 112 with a hole 113 fixed on another end thereof. The holder 12 includes a tetragonal fitting portion arranged on one end thereof to fit with a hand tool or a pneumatic tool and a chamber 122 to receive a first spring 123 attached on another end thereof, and includes two orifices 124 to communicate with the chamber 22. The chamber 122 of the holder 12 is provided to receive the spherical knob 111 of the tool set 11. A positioning bolt 13 is inserted through the orifice 124 and the hole 113 so that the tool set 11 is connected with the holder 12. The holder 12 also includes a second spring 14 and loop 15 with a block 151. The loop 15 includes a covering periphery 152 above the block 151, and a C-shaped retainer 16 retained with the holder 12 is located at on one side of the covering periphery 152 of the loop 15, such that the loop 15 is defined in the holder 12 to prevent from a disengagement. However, such a conventional universal joint still has the following disadvantages:

1. When the tool set 11 is broken, the entire universal joint 10 has to be discarded, consuming tool cost.
2. The holder 12 only cooperates with a single tool set in a specific type and size without being applicable for different types and sizes of tool sets, consuming tool cost.
3. It is inconvenient for the user to carry this conventional universal joint because different types and sizes of universal joints have to match with corresponding tool sets individually.

The present invention has arisen to mitigate and/or obviate the afore-described disadvantages.

### SUMMARY OF THE PRESENT INVENTION

The primary object of the present invention is to provide an universal joint that is capable of rotating the holder and the tool set simultaneously so that when replacing the tool set, the sleeve member is controlled to release a limitation of the tool set, thus replacing different tool sets easily.

Further object of the present invention is to provide an universal joint of which the holder and the tool set are capable of being separated or connected together so that when one of the holder and the tool set is broken, it is replaced to prevent from replace the entire universal joint.

Another object of the present invention is to provide an universal joint of which the holder is capable of matching with different tool sets to be portable easily.

Accordingly, in order to accomplish the above objects, the present invention provides an universal joint pick up tool comprising a tool set having a driving portion disposed on one end thereof and a spherical knob fixed on another end thereof, and the spherical knob further comprising two retaining segments disposed on two sides thereof respectively, a holder having a fitting portion disposed on one end thereof and a chamber fixed on another end thereof to receive the spherical knob, and between the holder and the tool set being defined a locking structure, wherein the locking structure includes a hole fixed on the retaining segment of the tool set to communicate with the chamber. The hole includes a lock boss placed therein and a sleeve member fitted thereon. The sleeve member includes an abutting face for pushing the lock boss to extend out of the chamber of the holder to engage with the retaining segments.

### BRIEF DESCRIPTION OF THE DRAWINGS

FIG. 1 is a cross sectional view showing the assembly of a conventional universal joint of TW Pat. No. 87218189;

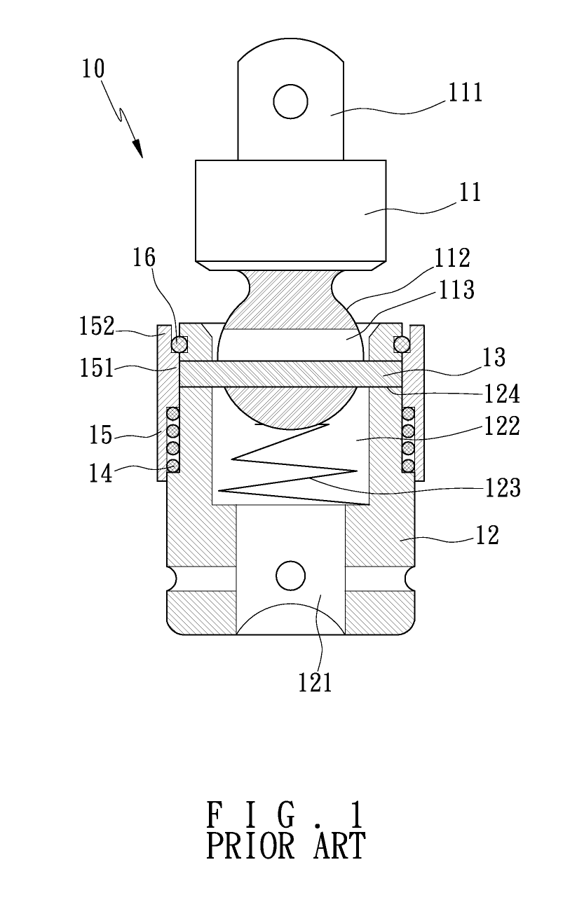

FIG. 2 is a perspective view showing the exploded components of an universal joint according to a preferred embodiment of the present;

FIG. 3 is a perspective view showing the assembly of the universal joint according to the preferred embodiment of the present;

FIG. 4 is a cross sectional view showing the assembly of the universal joint according to the preferred embodiment of the present;

FIG. 5 is another cross sectional view showing the assembly of the universal joint according to the preferred embodiment of the present;

FIG. 6 is a cross sectional view showing the operation of the universal joint according to the preferred embodiment of the present;

FIG. 7 is another cross sectional view showing the operation of the universal joint according to the preferred embodiment of the present;

FIG. 8 is also another cross sectional view showing the operation of the universal joint according to the preferred embodiment of the present;

FIG. 9 is another cross sectional view showing the operation of the universal joint according to the preferred embodiment of the present;

FIG. 10 is also another cross sectional view showing the operation of the universal joint according to the preferred embodiment of the present;

FIG. 11 is another cross sectional view showing the operation of the universal joint according to the preferred embodiment of the present;

FIG. 12 is a perspective view showing the holder of the present invention matching with different tool sets.

### DETAILED DESCRIPTION OF THE PREFERRED EMBODIMENT

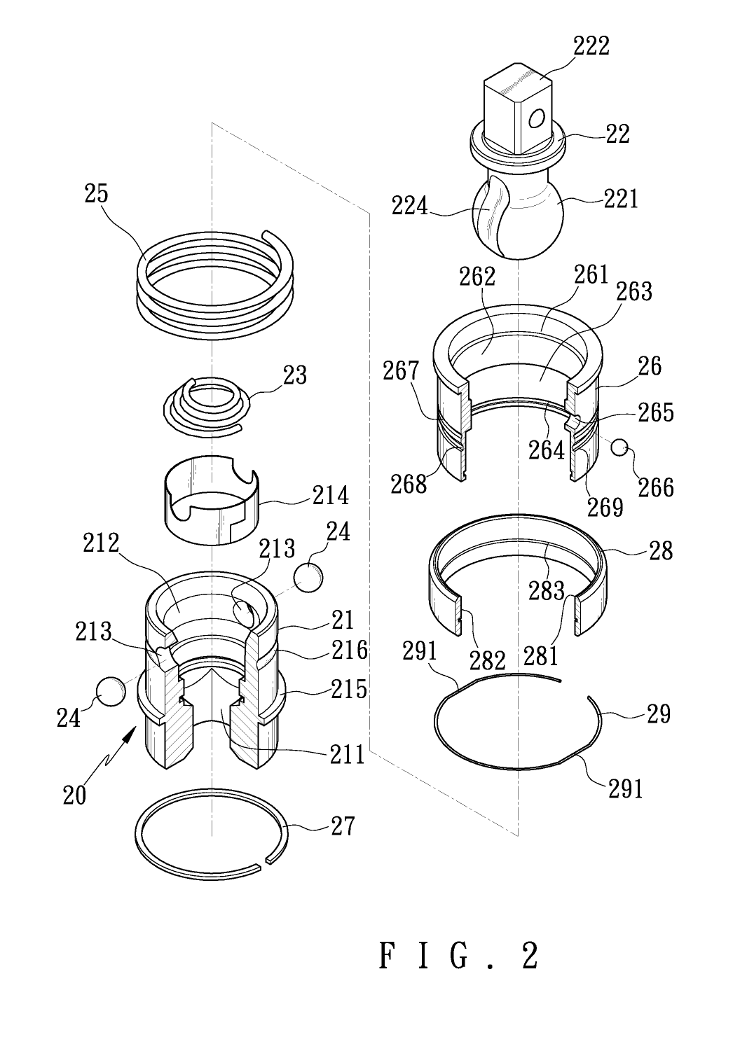

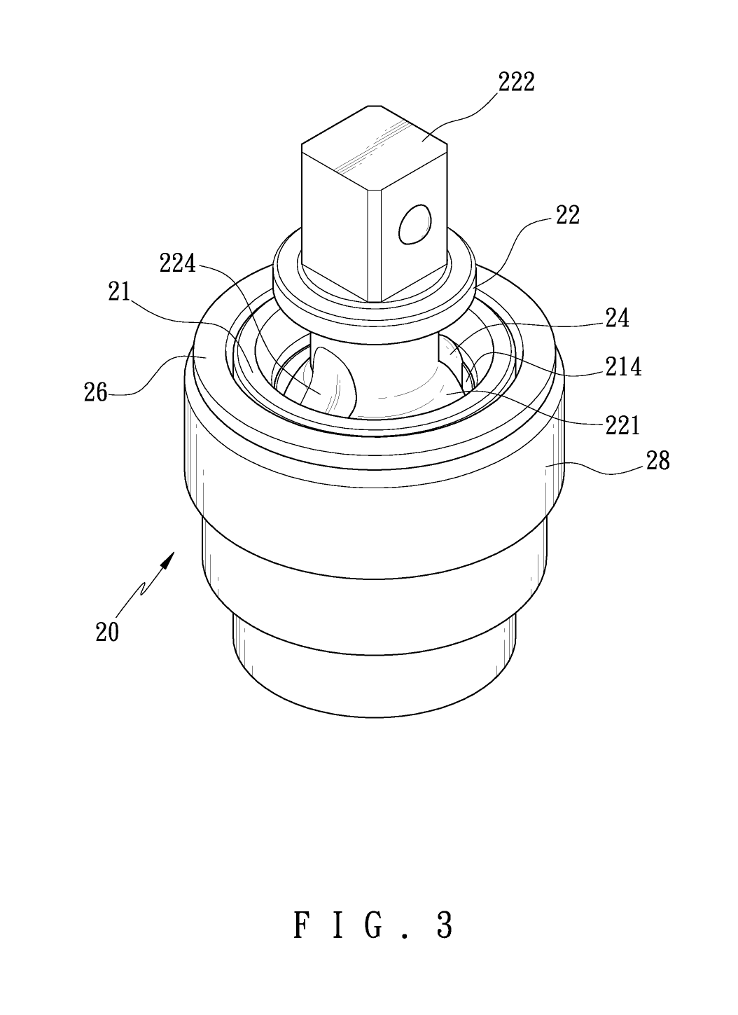

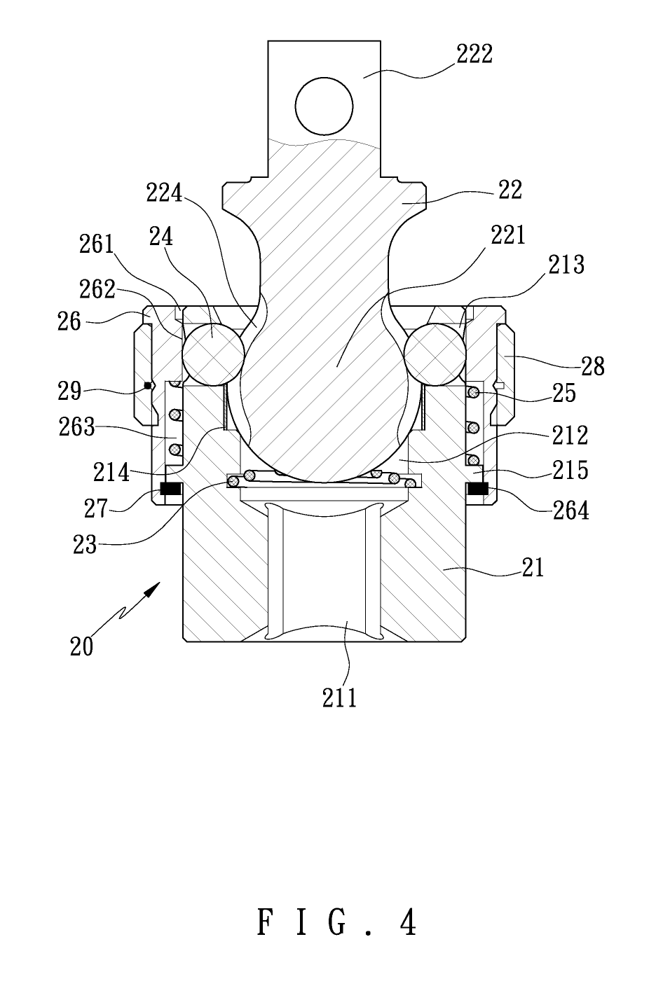

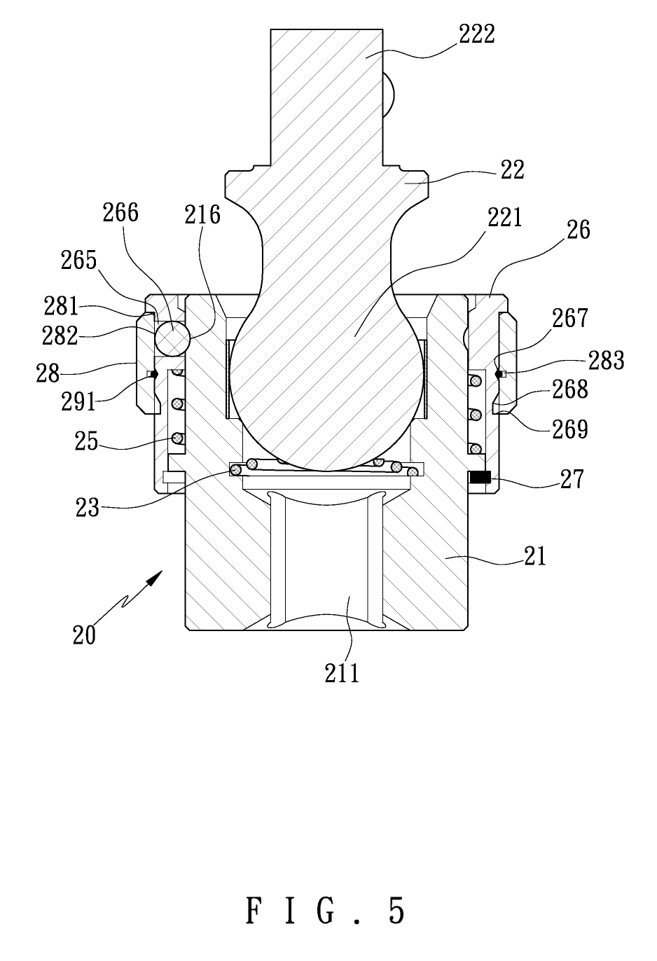

Referring to FIGS. 2-5, an universal joint 20 capable of replacing various tool sets in accordance with a preferred embodiment of the present invention comprises a holder 21 and a tool set 22, the holder 21 including a tetragonal fitting portion 211 disposed on one end thereof and a chamber 212 fixed on another end thereof, the tool set 22 including a driving portion 222 secured on one end thereof and capable of being formed in various shapes and sizes. In this embodiment, the driving portion 222 is formed in a tetragonal column shape and includes a steel ball to engage with a socket. The tool set 22 also includes a spherical knob 221 attached on another end thereof to be fitted into the chamber 212 of the holder 21 and to extend the driving portion 222 out of the holder 21. The spherical knob 221 includes two retaining segments 224 disposed on two sides thereof respectively. In this embodiment, each retaining segment 224 is a recess, and the chamber 212 of the holder 21 includes a first spring 23 received therein to abut against the spherical knob 221 of the tool set 22 outward. Between the holder 21 and the tool set 22 are defined a locking structure including a hole 213 fixed on the retaining segment 224 of the tool set 22 to communicate with the chamber 212. The hole 213 has a lock boss 24 placed therein and formed in a ball shape so as to move along the hole 213 to extend out of the chamber 212. The holder 21 also includes a limiting loop 214 retained therein to limit an extending range of the lock boss 24 and a peripheral rib 215 formed around an outer surface thereof and fitted with a second spring 25 and a sleeve member 26. The sleeve member 26 includes a first slot 261 formed on one end of an inner wall thereof, an abutting face 262 below the first slot 261, a cavity 263 arranged on another end of the inner wall thereof to receive the second spring 25, and a second slot 264 below the cavity 263 in response to the peripheral rib 215 of the holder 21 to retain with a C-shaped retainer 27, thereby preventing the sleeve member 26 from disengagement from the holder 21, and that the second spring 25 is provided to push the sleeve member 26 to be located at the hole 213 of the holder 21, such that the lock boss 24 is pushed to extend out of the chamber 212 to engage with the retaining segment 224 of the spherical knob 221 of the tool set 22, and the retaining segment 224 is retained with the spherical knob 221 of the tool set 22 to limit the spherical knob 221. The sleeve member 26 is pushed so that the first slot 261 moves toward the hole 213 of the holder 21. Hence, the lock boss 24 is capable of moving outward along the hole 213 to further disengage from the spherical knob 221 of the tool set 22. In addition, between the holder 21 and the sleeve member 26, an engaging structure is defined, wherein the engaging structure includes a positioning portion 216 (such as a groove) formed around the outer surface of the holder 21, an orifice 265 fixed on the sleeve member 26 in response to the positioning portion 216, a contacting element 266 (i.e. a circular ball) secured in the orifice 265 and moving inward along the orifice 265 to engage with the positioning portion 216 of the holder 21, a first notch 267 with a first tilted guiding face disposed around an outer wall of the sleeve member 26 and a second notch 268 with a second tilted guiding face fixed around the outer wall of the sleeve member 26 as well, a stop face 269 located at one side of the second notch 268, and a sheath 28 fitted on the sleeve member 26 to move axially. The sheath 28 includes a first annular gap 281 formed on a top end of an inner wall thereof, a pushing face 282 below the first annular gap 281, and a second annular gap 283 below the pushing face 282 to retain a flexibly expandable fixing member 29 with a limit portion 291 allowing to axially move with the sheath 28 so as to be retained in the first notch 267 of the sleeve member 26, the pushing face 282 of the sheath 28 is moved into the orifice 265 of the sleeve member 26 to limit the contacting element 266 to be engaged with the positioning portion 216 of the holder 21. The sleeve member 26 is fixed in a pressing manner so that the lock boss 24 engages with the retaining segment 224 of spherical knob 221 of the tool set 22, and the limit portion 291 of the fixing member 29 allows to move to further retain with a second notch 268 of the sleeve member 26. The first annular gap 281 of the sheath 28 is displaced into the orifice 265 of the sleeve member 26 so that the contacting element 266 displaces outward along the orifice 265 to disengage from the positioning portion 216 of the holder 21, thus releasing the sleeve member 26. Thereafter, the sheath 28 moves continuously so that the limit portion 291 of the fixing member 29 pushes the stop face 269 of the sleeve 26, hence the lock boss 24 disengages from the retaining segment 224 of spherical knob 221 of the tool set 22.

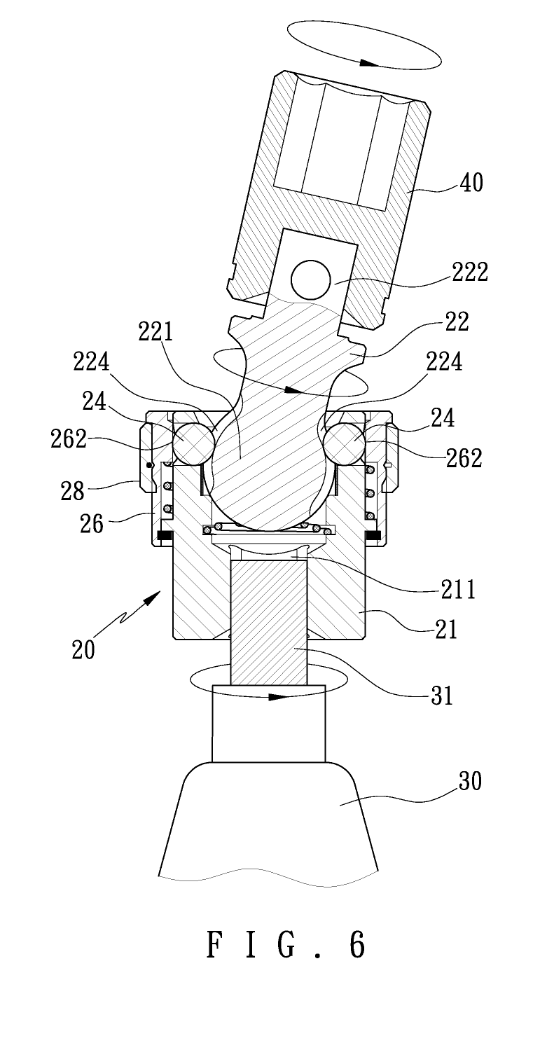

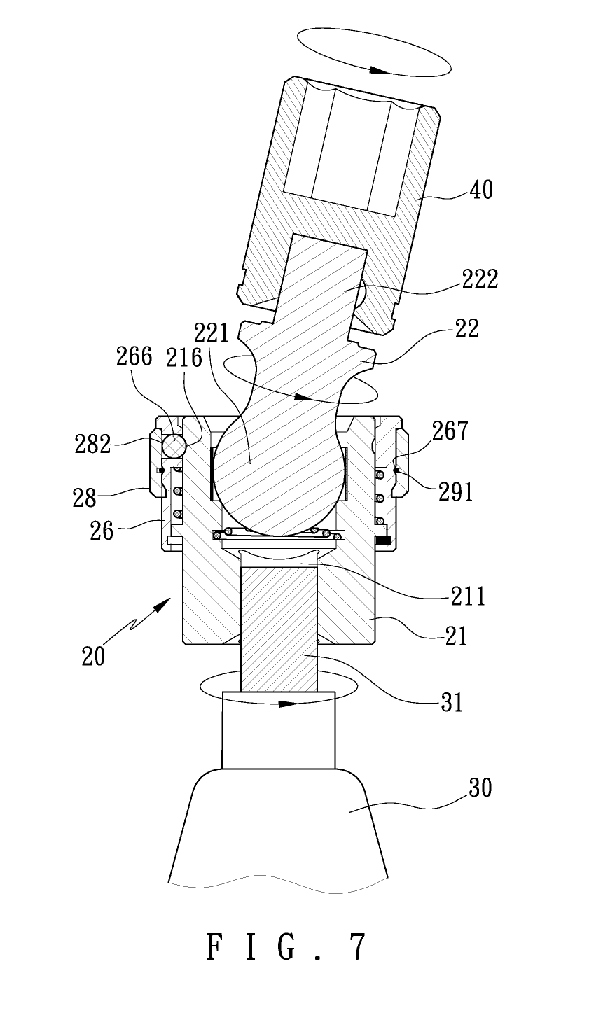

Referring to FIGS. 6 and 7, in operation of the universal joint 20, the fitting portion 211 of the holder 21 is connected with a coupling portion 31 of a drive tool 30 (such as a pneumatic tool), and the driving portion 222 of the tool set 22 is installed with a socket 40. When the coupling portion 31 of the drive tool 30 is rotated, the holder 21 of the universal joint 20 is actuated to move. Since the lock boss 24 of the holder 21 engages with the retaining segment 224 of the tool set 22, the tool set 22 is actuated to move simultaneously so that the tool set 22 drives the socket 40 to rotate, thereby removing the bolt element. During actuating the socket 40, if the sleeve member 26 is pressed suddenly, the engaging structure between the holder 21 and the sleeve member 26 is used to make the abutting face 262 of the sleeve member 26 to be positioned at the hole 213 of the holder 21 so that the lock boss 24 engages with the retaining segment 224 of the spherical knob 221 of the tool set 22 to prevent the tool set 22 and the holder 21 from disengagement during rotation.

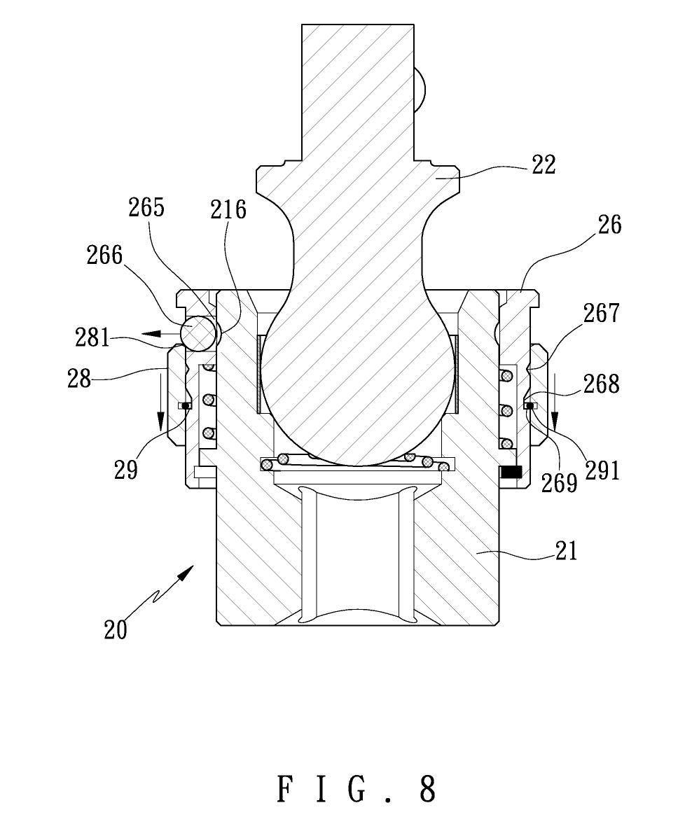

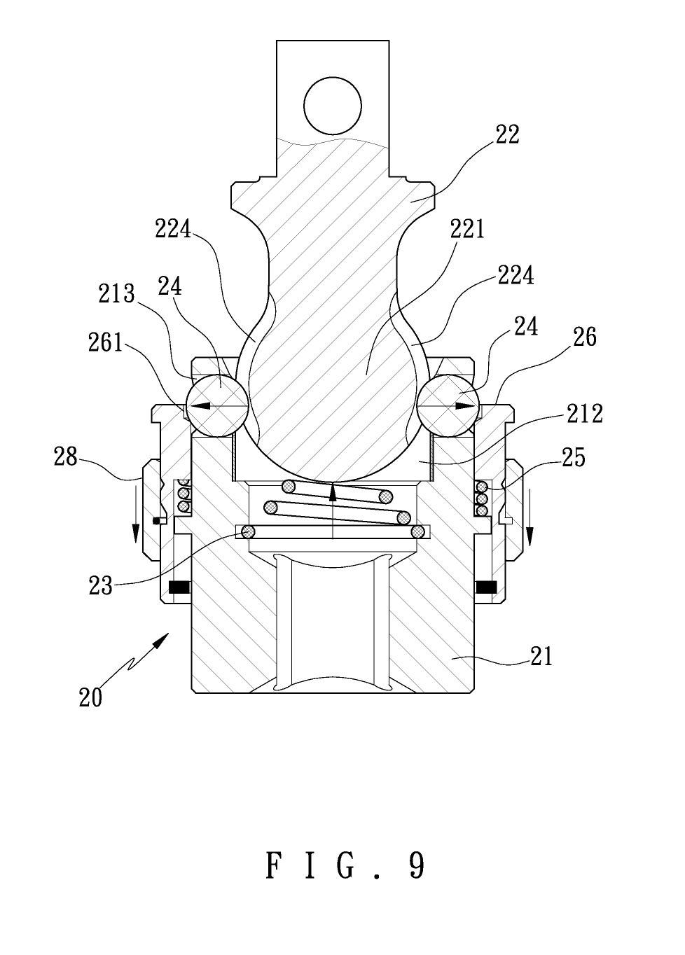

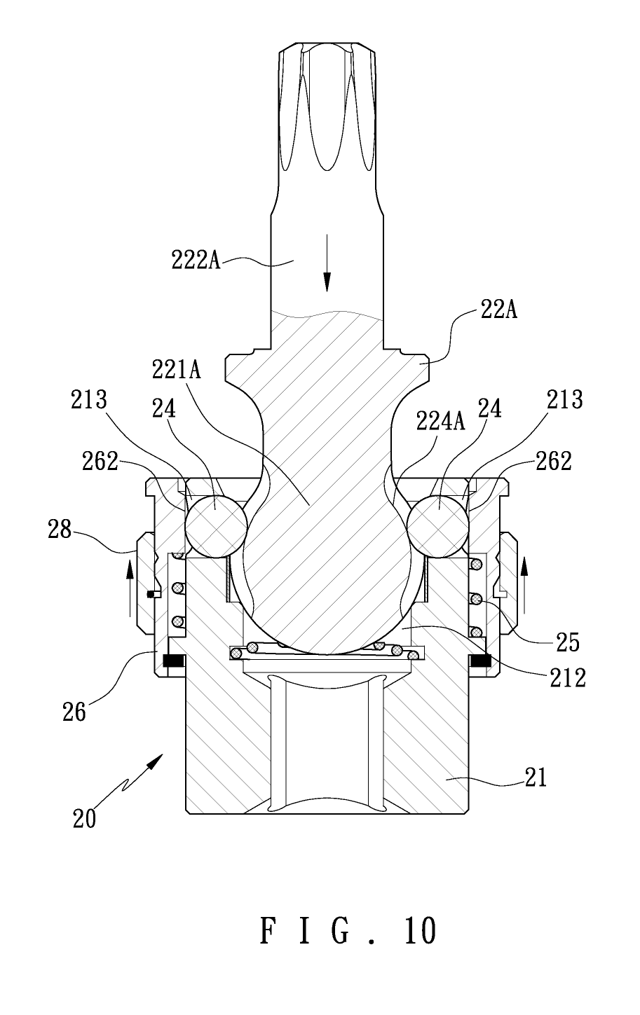

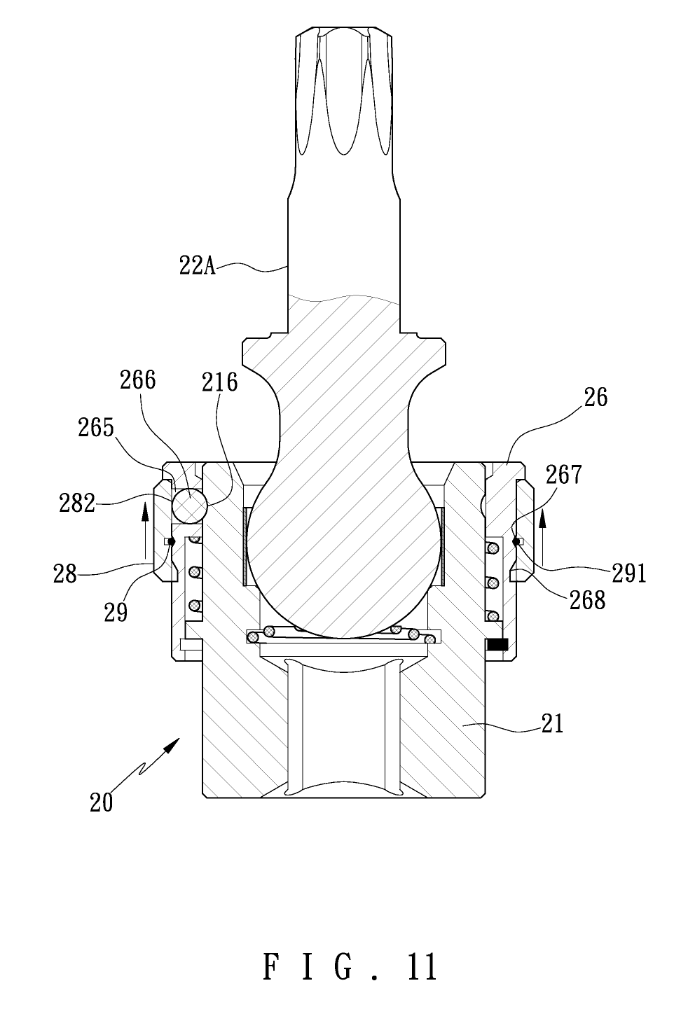

As illustrated in FIG. 8, when replacing the tool set 22 on the holder 21 of the universal joint 20, the sheath 28 is pressed and the limit portion 291 of the fixing member 29 displaces downward with the sheath 28 to further disengage from the first notch 267 of the sleeve member 26. Thereafter, the sheath 28 is pressed continuously so that the limit portion 291 of the fixing member 29 displaces to be retained in the second slot 268 of the sleeve member 26. Besides, the first annular gap 281 of the sheath 28 moves into the orifice 265 of the sleeve 26 so that the contacting element 266 disengages from the positioning portion 216 of the holder 21 to release the sleeve member 26, and that the sheath 28 is pressed continuously so that the limit portion 291 of the fixing member 29 pushes the stop face 269 of the sleeve member 26, thus displacing the sleeve member 26 downward. Referring further to FIG. 9, the sheath 28 is pressed to push the sleeve member 26 to move downward so that the second spring 25 is compressed, and that the first slot 261 of the sleeve member 26 moves into the hole 213 of the holder 21, therefore the lock boss 24 disengages from the retaining segment 224 of the spherical knob 221 of the tool set 22, such that the first spring 23 moves outward to abut against the spherical knob 221 of the tool set 22. In the meantime, the retaining segment 224 of the tool set 22 pushes the lock boss 24 to move outward along the hole 213 so that the spherical knob 221 of the tool set 22 disengages from the chamber 212 of the holder 21, thus removing the tool set 22 from the holder 21. As illustrated in FIG. 10, when desiring to replace a screw-bit driving portion 222A of a tool set 22A based on requirement, the spherical knob 221A of the tool set 22A is placed into the chamber 212 of the holder 21, and then the sheath 28 and the sleeve member 26 are released. The second spring 25 pushes the sleeve member 26 to move back to an original position so that the abutting face 262 of the sleeve member 26 displaces into the hole 213 of the holder 21, and that the two lock bosses 24 are pushed to move inward to further extend out of the chamber 212 of the holder 21. Hence, the abutting face 262 of the sleeve 26 limits the lock bosses 24 to engage with the retaining segment 224A of the spherical knob 221A of the tool set 22A, and the lock bosses 24 retain with the spherical knob 221 of the tool set 22 to prevent the tool set 22A from disengagement from the holder 21. With reference to FIG. 11, the sheath 28 is pushed upward, and the limit portion 291 of the fixing member 29 displaces upward with the sheath 28 to further disengage from the second notch 268 of the sleeve member 26, thereafter the limit portion 291 is retained in the first notch 267 of the sleeve member 26, and the pushing face 282 of the sheath 28 moves into the orifice 265 to limit the contacting element 266 to be retained in the positioning portion 216 of the holder 21, such that the sleeve member 26 is fixed to prevent the tool set 22A from disengaging from the holder 21 during rotation, thereby connecting the tool set 22A with the holder 21 easily.

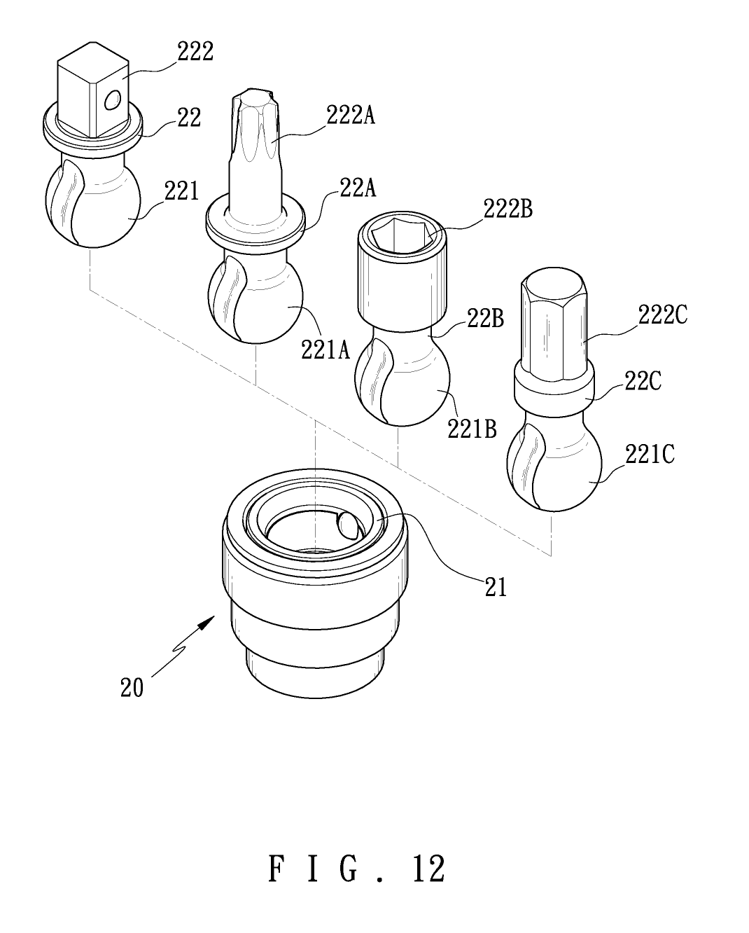

Referring to FIG. 12, the holder 21 and the tool set 22 are capable of being designed separately, e.g., the single holder 21 is capable of matching with different tool sets with various driving portions. For example, a screw-bit driving portion 222A matches with the spherical knob 221A of the toolset 22A; a socket driving portion 222B cooperates with a spherical knob 221B of a tool set 22B; or an allen-wrench driving portion 222C associates with a spherical knob 221C of a tool set 22C so that the sheath 28 and the sleeve member 26 are controlled to replace different types of tool sets 22, 22A, 22B, 22C, thus removing various bolt elements.

Thereby, only one holder 21 has to be produced to match with different types of tool sets 22, 22A, 22B, 22C, lowering production cost and carrying easily.

The invention is not limited to the above embodiment but various modifications thereof may be made. It will be understood by those skilled in the art that various changes in form and detail may made without departing from the scope and spirit of the present invention.

What is claimed is:

1. An universal joint capable of replacing various tool sets comprising:
a tool set including a driving portion disposed on one end thereof and a spherical knob fixed on another end thereof, wherein said spherical knob having two retaining segments disposed on two sides thereof respectively;
a holder including a fitting portion disposed on one end thereof and a chamber fixed on another end thereof to receive said spherical knob, and between said holder and said tool set being defined a locking structure, wherein said locking structure includes a hole fixed on the retaining segment of said tool set to communicate with tsaid chamber, said hole having a lock boss placed therein, the holder also including a sleeve member fitted thereon, wherein said sleeve member including an abutting face for pushing said lock boss to extend out of said chamber of said holder to engage with said retaining segments.

2. The universal joint capable of replacing various tool sets, as recited in claim 1, wherein said chamber of said holder comprising a first spring received therein to abut against said spherical knob of tsaid tool set outward.

3. The universal joint capable of replacing various tool sets, as recited in claim 1, wherein each retaining segment is a recess, and said lock boss is formed in a ball shape.

4. The universal joint capable of replacing various tool sets, as recited in claim 1, wherein said holder further comprising a limiting loop retained therein to limit an extending range of said lock boss.

5. The universal joint capable of replacing various tool sets, as recited in claim 1, wherein said holder further comprising a peripheral rib formed around an outer surface thereof and fitted with a second spring and said sleeve member, said sleeve member having a first slot formed on one end of an inner wall thereof, an abutting face below the first slot, a cavity arranged on another end of the inner wall thereof to receive said second spring, and a second slot below the cavity in response to said peripheral rib of said holder to retain with a C-shaped retainer.

6. The universal joint capable of replacing various tool sets, as recited in claim 1, wherein between said holder and said sleeve member is defined an engaging structure to position said sleeve member.

7. The universal joint capable of replacing various tool sets, as recited in claim 6, wherein said engaging structure further comprising a positioning portion formed around the outer surface of said holder, an orifice fixed on said sleeve member in response to said positioning portion, a contacting element secured in the orifice, a sheath fitted on said sleeve member to move axially, said sheath including a first annular gap formed on a top end of an inner wall thereof, a pushing face below said first annular gap, such that the pushing face of said sheath is capable of limiting the contacting element to be engaged with said positioning portion of said holder, and said first annular gap of said sheath is displaced into said orifice of said sleeve member so that said contacting element displaces outward along the orifice to disengage from said positioning portion of the holder, thus releasing said sleeve member.

8. The universal joint capable of replacing various tool sets, as recited in claim 7, wherein said positioning portion is a groove, and said contacting element is a circular ball.

9. The universal joint capable of replacing various tool sets, as recited in claim 7, wherein said sleeve member includes a first notch with a first tilted guiding face disposed around an outer wall thereof and a second notch with a second tilted guiding face fixed around the outer wall thereof, wherein said sheath includes a second annular gap below said pushing face to retain a fixing member with a limit portion allowing to axially move with said sheath so as to be retained in said first notch and said second notch of said sleeve member.

10. The universal joint capable of replacing various tool sets, as recited in claim 9, wherein said sleeve member includes a stop face located at one side of said second notch so that said limit portion of said fixing member pushes said stop face of said sleeve, hence said lock boss disengages from said retaining segment of said spherical knob of said tool set.
